(19) United States
(12) Patent Application Publication
(10) Pub. No.: US 2002/0018673 A1
(43) Pub. Date: Feb. 14, 2002

(54) Color image forming apparatus

(76) Inventors: Yoshihiro Mizoguchi, Fukuoka (JP); Tadashi Shimotoso, Fukuoka (JP); Takashi Yoshihara, Fukuoka (JP); Yuji Nagai, Fukuoka (JP); Kazuhiro Ogata, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 09/851,107

(22) Filed: May 9, 2001

(30) Foreign Application Priority Data
May 11, 2000 (JP) 2000-138658

(51) Int. Cl. G03G 15/01

(52) U.S. Cl. 399/298; 399/299; 399/302

(57) ABSTRACT

Disclosed here is a color-image forming apparatus that minimizes damage caused by friction between a photosensitive drum and an inter-stage transfer belt. The apparatus includes a plurality of image-forming units, each of which has the photosensitive drum carrying an electrostatic latent image thereon, a developing unit forming a toner image by applying toner to the latent image. Having separately different color toner therein, each image-forming unit is organized into a tandem layout. The inter-stage transfer belt is looped over plural rollers on its way of the endless path. While traveling the path along in the direction that the image-forming units are arranged, the belt forms a full-color toner image thereon by transferring plural toner-images on the drums one upon another. The belt is controlled to come into contact with the drums only while accepting the toner image from the drums.

### FIELD OF THE INVENTION

The present invention relates to a color-image forming apparatus equipped with a photosensitive drum and a transfer belt that forms an image by overlapping several pieces of image information through electro-photography and other technologies.

### BACKGROUND OF THE INVENTION

In the prior-art color-image forming apparatus applying electro-photography, an image has been typically formed through the procedures below:

i) a charger charges a photosensitive drum serving as an image-carrier;

ii) Accepted laser radiation according to image information, the photosensitive drum forms an electrostatic latent image thereon;

iii) a developing unit develops the electrostatic latent image into a toner image to be visible; then

iv) the visualized toner image is transferred onto a sheet of paper or other sheet-type materials.

Responding to the needs for color image, many kinds of tandem type color-image forming apparatuses have been developed so far.

A typical tandem type apparatus has plural image-carriers-each carrier is responsible for carrying cyan-, magenta-, yellow-, and preferably black-image. The individual four images are formed on their respective carriers in the series of image-forming process described above. All of the separately carried images are overlapped at a proper position of each carrier and transferred onto a recording material to form a full-color image.

In another tandem type color-image forming apparatus, the toner images formed on the respective image-carriers are temporally transferred onto an inter-stage transfer member one upon another. After that, the overlapped full-color toner image is transferred onto a recording material in one operation.

Such a tandem type apparatus contributes to a high-speed image forming from its structure in which the each color image has its specific image-forming section.

FIG. 20 shows a schematic diagram of the prior-art color-image forming apparatus. In the apparatus shown in FIG. 20, image-forming units 41, 42, 43, and 44 form toner images colored in black (K), cyan (C), magenta (M), and yellow (Y), respectively. According to an image signal from exposure unit 45, photosensitive drums 41a, 42a, 43a, and 44a disposed in image-forming units 41, 42, 43, and 44, respectively, form each electrostatic latent image thereon. Inter-stage transfer belt 46 has a closed-loop structure. Transfer unit 47 transfers the respective toner images formed on drums 41a, 42a, 43a, and 44a onto belt 46. Fixing unit 48 finally transfers the toner image from belt 46 to sheet P fed from paper cassette 49 and fixes the image into place.

Here will be described the inner structure of image-forming units 41 through 44 in some detail. In image-forming unit 41 for black (K), for example, a laser beam from exposure unit 45 creates an electrostatic latent image over the peripheral surface of photosensitive drum 41a. Developing roller 41c applies toner onto the latent image formed on drum 41a to obtain a visible image. Cleaner 41d cleans out the residual toner on drum 41a after the toner image has been transferred onto belt 46. The procedure described above is performed in other units 42 through 44.

In such structured color-image forming apparatus, here will be described, for example, how the latent image carrying black component is formed on the drum.

Firstly, Charger 41b evenly charges over photosensitive drum 41a responsible for black. Then, according to image information from the host computer (not shown), exposure unit 45 applies laser light onto drum 41a to create a latent image. A thin layer of toner on developing roller 41c allows the latent image to be visible as a black-toner image. Having a contact with drum 41a, inter-stage transfer belt 46 travels in the direction indicated by the arrow A shown in FIG. 20. The visualized black-toner image is transferred onto belt 46 through the application of transferring pressure from the inside of belt 46 to transfer unit 47.

In the meantime, the latent image of the cyan component is created and then developed into a visible cyan-toner image with the help of cyan-toner layered on developing roller 42c. The cyan-toner image is transferred to belt 46 where the transfer process for the black-toner image has just been provided, thereby the two images are overlapped with each other.

In the same manner, the magenta- and the yellow-toner images are formed and overlapped with one after another. Thus, belt 46 carries the four-color overlapped image thereon.

The full-color toner image on belt 46 is finally transferred by transfer roller 50 onto sheet P coming from paper cassette 49. After that, sheet P travels through fixing unit 48 to have the toner image fixed thereon, and goes out in the direction B shown in FIG. 20.

After the toner image has been transferred onto sheet P, the residual toner on belt 46 is cleared out by belt cleaner 51.

According to the prior-art apparatus, however, its structure—the photosensitive drum contacts with the inter-stage transfer belt at all times—can raise a problem. If there is a difference in speed between the rotation of the drum and the running of the transfer belt, damage or wear can occur on the surfaces rubbing against each other, which may result in degradation in image quality or loss of life.

A suggestion that the drive timing of the drum should agree with that of the belt may be a remedy for the problem described above. However, initiating the operation of the two units with exact same drive-timing is practically impossible due to a time-lag lies in the driving systems—a delay in response of a motor, gears, and an actuator—of the drum and the belt. Therefore, minute abrasion will persist in such a situation.

Besides, electric current required to drive a motor sees its peak at just beginning of rotation. Therefore, a surge of power would be the result if such driving devices started their operations in unison.

Furthermore, even in the case that only one color, for example, monochrome (usually, black) print is required, other image-forming units—units for cyan, magenta, and yellow—also have to work with an “idle” printing motion. This wasteful motion produces friction between the members forming the photosensitive drum, the developing roller, and the cleaner, shortening their useful life.

In the event of an interruption of the printing due to paper jamming or other malfunctions, the toner image left of the drum and the inter-stage transfer belt has to be cleaned out for the next printing. Being typical of the structure of the tandem type apparatus, the transfer belt requires much longer time to travel a round than the drum needs to rotate one turn. That is, the drum has to have unnecessarily several turns while the belt travels at least a round. This structural inconveniency also causes friction between parts forming the image-forming units, reducing their longevity.

### SUMMARY OF THE INVENTION

The object of the present invention is to provide a color-image forming apparatus having the structure that minimizes damage in the photosensitive drum and the inter-stage transfer belt due to friction occurred between them.

The apparatus of the present invention includes an exposure unit, plural image-forming units, and an endless inter-stage transfer belt.

The image-forming units are organized in the tandem type arrangement, each of which contains: i) own photosensitive drum on which an electrostatic latent image is formed by the exposure unit; ii) own developing unit forming a toner image by applying toner onto the latent image. In addition, each unit has toner of different color. Looped over plural rollers in its traveling path, the endless inter-stage transfer belt runs a round along in the direction of the arrangement of the image-forming units. A full-color toner image is formed on the belt as it runs, overlapped each toner image formed on each drum with one upon another.

In the process, the belt comes into contact with the drum only while the toner image is transferred from the drum onto the belt. Keeping the belt from contact with the drum except for the transfer process of the toner image reduces damage or abrasion from friction between the drum and the belt at the start of rotation. That is, the image-forming unit and the transfer belt have a longer service life.

### BRIEF DESCRIPTION OF THE DRAWINGS

FIG. 1 shows a schematic diagram illustrating the structure of the color-image forming apparatus in accordance with a first preferred embodiment of the present invention.

FIGS. 2 (a) and 2 (b) illustrate the image-forming unit for yellow and the engaging/disengaging mechanism of a first transfer roller in the apparatus.

FIG. 3 is a perspective view indicating the essential part of an inter-stage transfer belt unit of the apparatus.

FIG. 4 is a perspective view indicating a guide member of the transfer belt unit.

FIG. 5 is a perspective view indicating a trigger of the belt unit.

FIG. 6 is a schematic view of the color-image forming apparatus, specifically showing the engaging relation between the trigger and the guide member when all of the first transfer rollers stay in the disengaging positions.

FIG. 7 is a schematic view of the apparatus, specifically showing the engaging relation between the trigger and the guide member when all of the first transfer rollers stay in the engaging positions.

FIG. 8 is a perspective view indicating driving units of the apparatus.

FIG. 9 is a perspective view indicating the positional relation between the inter-stage transfer belt and the image-forming unit in the apparatus.

FIG. 10 is a timing chart indicating the operation of the apparatus.

FIG. 11 schematically shows the image-forming unit for yellow and the trigger responsible thereto in accordance with a second preferred embodiment.

FIGS. 12 (a) and 12 (b) illustrate variations occurred when the first transfer roller comes into contact with the inter-stage transfer belt, comparing the cases in which different two types of triggers of the present invention are used.

FIG. 13 is a schematic view of the apparatus, specifically showing the engaging relation between the trigger and the guide member when all of the first transfer rollers stay in the disengaging positions in accordance with a third preferred embodiment of the present invention.

FIG. 14 is a schematic view of the apparatus, specifically showing the engaging relation between the trigger and the guide member when the first transfer roller responsible for black alone stays in the engaging position.

FIG. 15 is a schematic view of the apparatus, specifically showing the engaging relation between the trigger and the guide member when all of the first transfer rollers stay in the engaging positions.

FIG. 16 is a perspective view indicating the positional relation between the guide member and the sensor in the apparatus.

FIG. 17 is a schematic view of the apparatus, specifically showing the engaging relation between the trigger and the guide member when all of the first transfer rollers stay in the disengaging positions in accordance with a fourth preferred embodiment of the present invention.

FIG. 18 is a schematic view of the apparatus, specifically showing the engaging relation between the trigger and the guide member when the first transfer roller for black alone stays s in the engaging position.

FIG. 19 is a schematic view of the apparatus, specifically showing the engaging relation between the trigger and the guide member when all the first transfer rollers but the roller for black stay in the engaging positions.

FIG. 20 is a schematic view of the prior-art color-image forming apparatus.

### DESCRIPTION OF THE PREFERRED EMBODIMENTS

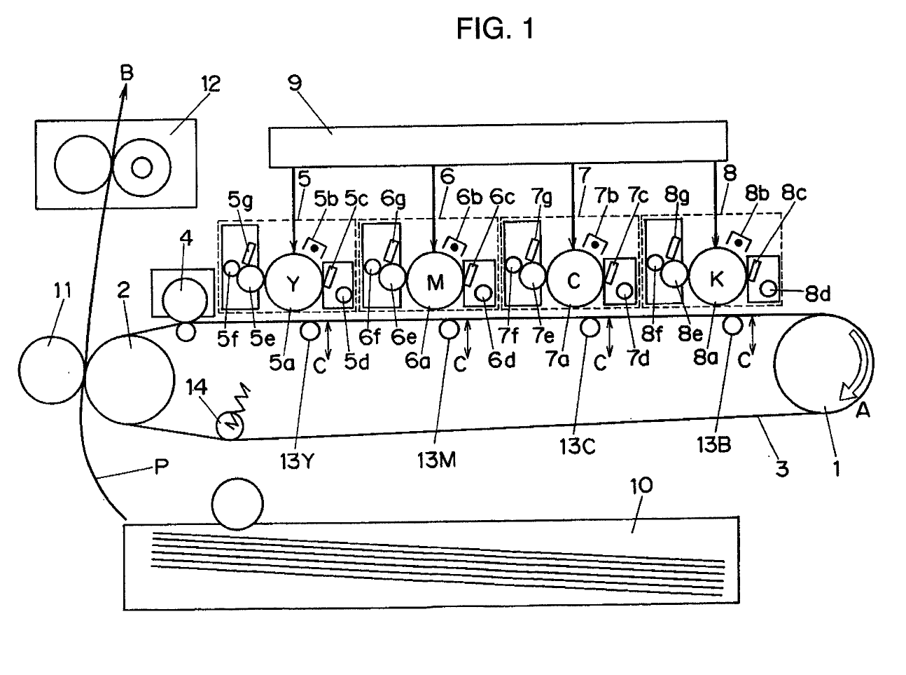

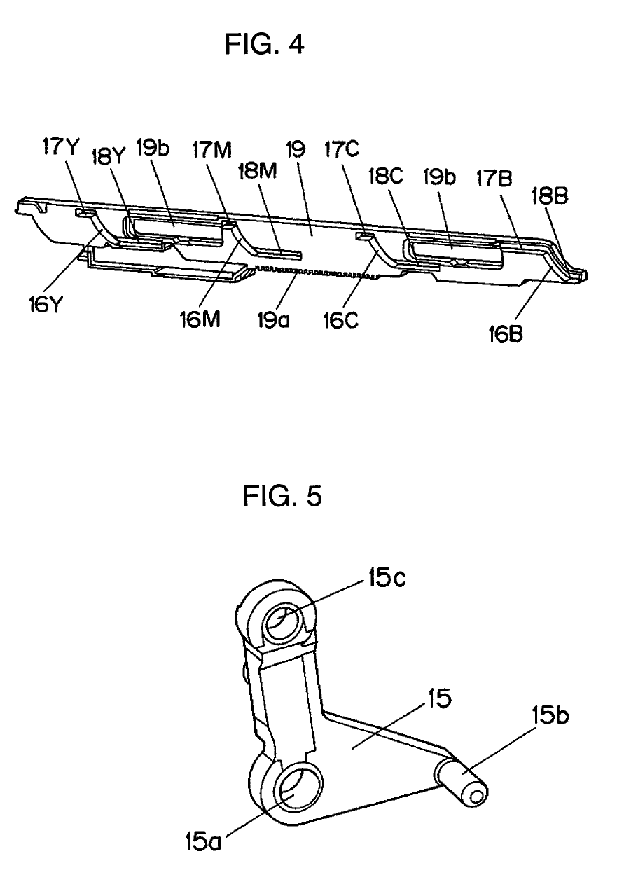

The preferred embodiments of the present invention are described hereinafter with reference to the accompanying drawings, FIG. 1 through FIG. 19. As for the members that are the same as those appear throughout the drawings, the same reference numerals will be provided and description thereof will be omitted.

First preferred embodiment

FIG. 1 shows a schematic diagram illustrating the structure of the color-image forming apparatus in accordance with the first preferred embodiment of the present invention.

As shown in FIG. 1, the apparatus includes inter-stage transfer belt 3 driven by belt-drive roller 1. Belt 3 is looped over belt-drive roller 1, belt-support roller 2, and tension roller 14 applying proper tension to belt 3.

Paper cassette 10 is located below the endless path of belt 3. Sheet P fed from paper cassette 10 travels between second transfer roller 11 and belt 3 and reaches fixing unit 12.

Exposure unit 9, which applies laser according to image information, is disposed above belt 3. Between exposure unit 9 and belt 3, image-forming units 5, 6, 7, and 8, which are responsible for yellow (Y), magenta (M), cyan (C), and black (K), respectively, are arranged along in the traveling direction of belt 3.

After nipped between second transfer roller 11 and belt 3, sheet P accepts the color toner image formed on belt 3. The transferred toner image is fixed onto sheet P by fixing unit 12.

Belt cleaning unit 4 is disposed between image-forming unit 5 and belt-support roller 2. It clears out the residual toner image from belt 3.

It will be understood that the present invention comprehends any arrangement, given an image-forming unit for black, i.e., monochrome print, and at least two different colors such as yellow, and the structure is not limited to the structure demonstrated in the embodiment.

Identically structured image-forming units 5 through 8 include each photosensitive unit and developing unit.

In the photosensitive unit, corona type chargers 5b, 6b, 7b, 8b evenly charge photosensitive drums 5a, 6a, 7a, 8a, and their surfaces, respectively. Cleaning blades 5c, 6c, 7c, and 8c clear out the residual toner from the surfaces of drums 5a, 6a, 7a, and 8a, respectively. The waste toner collected by cleaning blades 5c, 6c, 7c, and 8c are then carried by waste toner screws 5d, 6d, 7d, and 8d, respectively.

On the other hand, in each developing unit, developing rollers 5e, 6e, 7e, and 8e apply toner to each electrostatic latent image formed on drums 5a through 8a, respectively, allowing the latent images to be visible. Supply rollers 5f, 6f, 7f, and 8f supply each surface of developing rollers 5e through 8e, respectively, with toner from the toner tank (not shown). Spreading blades 5g, 6g, 7g, and 8g evenly spread the toner on rollers 5e through 8e,respectively, and apply a charge to them.

Corresponding to drums 5a, 6a, 7a, and 8a, first transfer rollers—movable rollers—13Y, 13M, 13C, 13B are disposed on the side of the inner radius of the traveling path of inter-stage transfer belt 3. Each of rollers 13Y through 13B has an engaging/disengaging mechanism working in the direction of the inner radius of belt 3—indicated by double-headed arrow C in FIG. 1, controlling belt 3 to come into contact with or to keep away from drums 5a, 6a, 7a, and 8a, respectively. Rollers 13Y through 13B are made of metal. The latent images carried on drums 5a through 8a can be transferred onto belt 3 by applying a high voltage to each of the first transfer rollers. The structure therefore realizes a compact-sized transfer-mechanism section without an extra transferring member that is required to the prior-art apparatus.

As a variation of the mechanism for contacting transfer belt 3 with drums 5a through 8a, a structure can be employed for the same transferring effect, such that image-forming units 5 through 8 move in the vertical direction to come into contact with first transfer rollers 13Y through 13B that are fixed in place. However, moving units 5 through 8 in the vertical direction inevitably take drums 5a through 8a with them. The fact can produce variations in obtaining correct focus by exposure unit 9 for latent-image formation. Such a structure can also produce unstable driving in the driving system responsible for rotating drums 5a through 8a.

Considering inconveniencies described above, the embodiment employs the structure having movable first transfer rollers 13Y through 13B disposed on the inner-radius side of transfer belt 3, allowing belt 3 to contact with drums 5a through 8a.

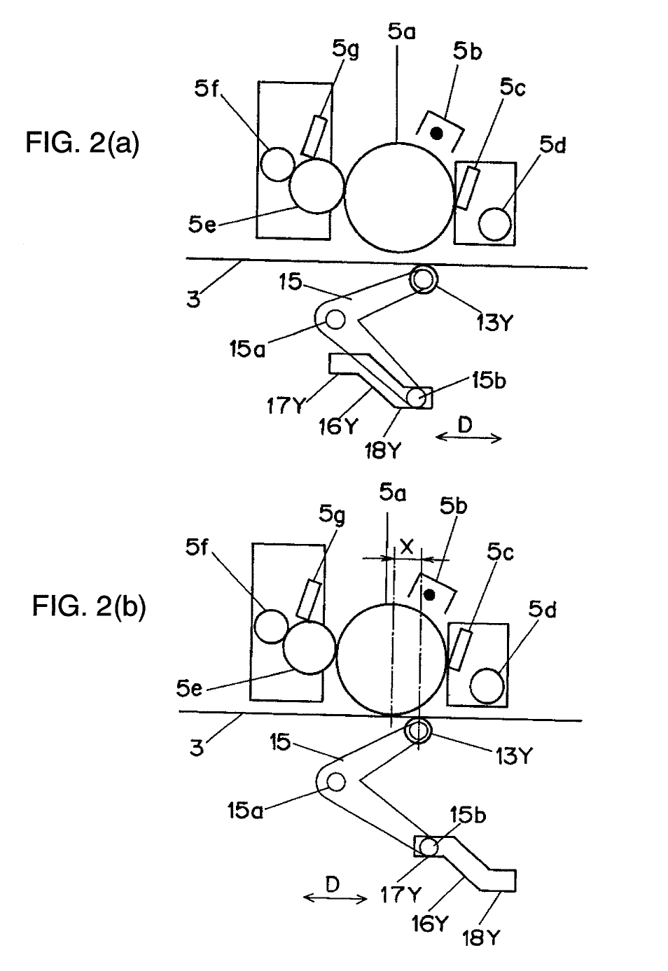

FIG. 2 illustrates the image-forming unit for yellow and the engaging/disengaging mechanism of a first transfer roller.

As shown in the figure, transfer roller 13Y is rotatably held at its both ends by trigger 15. Generally L-shaped, trigger 15 is rotatable about support pin 15a fixed at the bending section of trigger 15 to the apparatus. In the direction opposite to transfer roller 13Y, guide pin 15b is disposed at the position properly spaced from pin 15a. Controlling the position of pin 15b can set roller 13Y in place. Therefore, guide 16Y for controlling the position of pin 15b is arranged to be slidable in the direction indicated by the arrow D.

Guide 16Y contains apertures in which guide pin 15b is accepted and a ramp. As the shape of the opening is shown in FIG. 2, guide 16Y contains engaging stage 17Y and disengaging stage 18Y, which are provided in a parallel arrangement with respect to the sliding direction. Sliding motion of guide 16Y allows trigger 15 to rotate about pin 15a.

Here will be explained in a little more detail. When guide pin 15b stays on disengaging stage 18Y, as shown in FIG. 2 (a), first transfer roller 13Y is also in the disengaging position, which keeps inter-stage transfer belt 3 away from photosensitive drum 5a. On the other hand, in the state shown in FIG. 2 (b), when guide 16Y slides in the right direction from the state shown in FIG. 2 (a), guide pin 15b moves to engaging stage 17Y. At this time, roller 13Y pushes belt 3, as well as rotating to the engaging position, and reaches predetermined bite level with respect to drum 5a, allowing belt 3 to come into contact with drum 5a.

Photosensitive drum 5a is a delicate part that has an aluminum base over which a thin layer of an organic photo conductor or other photosensitive layer is provided. In order to protect drum 5a from damage, the contact position of roller 13Y with belt 3 is shifted from the contact position of drum 5a with belt 3 by distance X. This displacement thus avoids contacting drum 5a with roller 13Y via belt 3.

Roller 13Y may be formed by wrapping a metallic core with elastic members, such as foam and rubber, into a roll shape. Such structured roller 13Y can bite and come into contact with drum 5a via belt 3 due to its soft structure. With the structure, however, the elastic member has to be consistently controlled, for example, in its foam density, hardness, and resistance value. Variations in such factors can adversely affect the transfer characteristics, which fail to transfer an image to a desired position. Furthermore, this produces a disturbance in the transferred toner image, resulting in quality deficiencies in image. For this reason, roller 13Y is preferable made of metal.

As described above, by engaging guide pin 15b of trigger 15 with guide 16Y having engaging stage 17Y and disengaging stage 18Y, trigger 15 can be rotatably operated according to the movement of guide 16Y in the rightward/leftward direction. This allows belt 3 to come into contact with or to keep away from drum 5a. The structure—operating first transfer roller 13Y to be rotatable about support pin 15a with the help of trigger 15 and guide 16Y—is also employed for other transfer rollers 13M, 13C, and 13B in the same way.

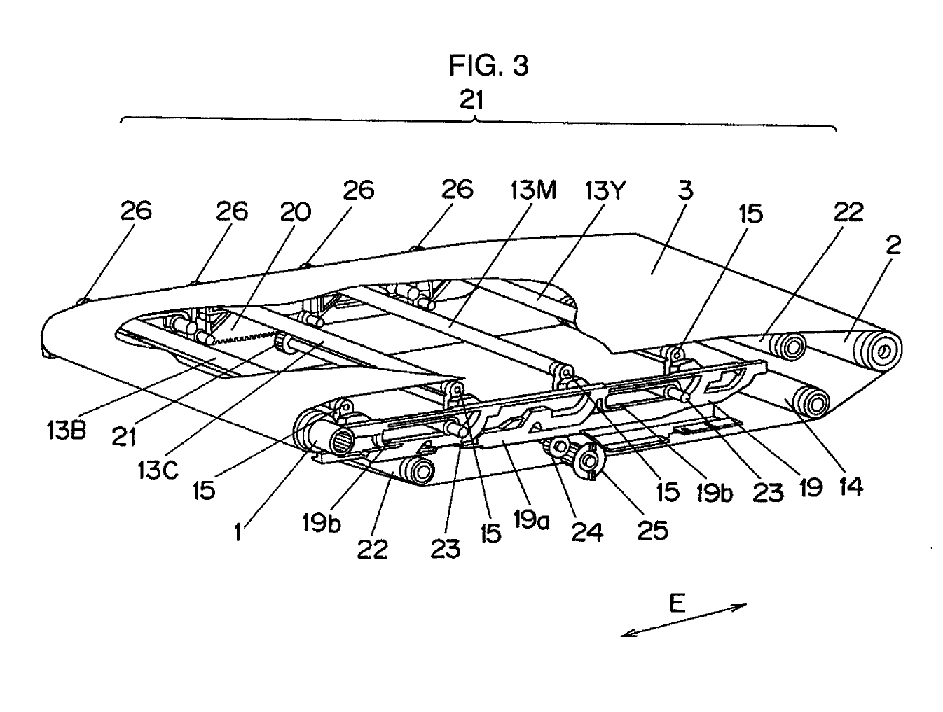

FIGS. 3, 4, and 5 are perspective views indicating the essential part of an inter-stage transfer belt unit, a guide member of the belt unit, and a trigger of the belt unit, respectively.

FIG. 3 shows the structure of inter-stage transfer belt unit 21, in which inter-stage transfer belt 3 is looped over i) belt-drive roller 1, ii) belt-support roller 2, iii) tension roller 14, iv) idle roller 22 so as to run the endless path. Inside the endless path, first transfer rollers 13Y through 13B are arranged. For convenience's sake, the frame by which the rollers are fixed—the foundation of unit 21—is not shown in the figure.

Guide member 19 is located along one of the widthwise ends of belt 3 so as to be slidable in the direction indicated by the arrow E, i.e., in an orthogonal direction with respect to the rows of image-forming units 5 through 8. On the other widthwise end of belt 3, guide member 20 is located in symmetric relation to member 19.

On the inner side of guide member 19, four guides 16Y, 16M, 16C, and 16B are formed corresponding to the positions of image-forming units 5 through 8. Member 19 also has rack 19a at its bottom edge, and two slots 19b that accept two guide-holding pins 23 formed on unit 21. Rack 19a engages with pinion 24 that is rotatably arranged on the side of unit 21. Pinion 24 further meshes with joint gear 25 engaging with the driving system (not shown) for the apparatus. This engagement allows joint gear 25 to rotate forward or backward according to the driving control transmitted from the apparatus, and guide member 19 accordingly slides in the direction indicated by the arrow E.

Guide members 19 and 20 should operate in an exactly synchronized motion. To ensure the in-phase movement, guide members 19, 20 and pinion 24 each have inscribed markings (not shown) for their proper positioning.

Trigger 15 is, as illustrated in FIG. 2, generally L-shaped. In FIG. 5, trigger 15 includes i) support pin 15a on which trigger 15 rotates; ii) guide pin 15b; and iii) roller bearing 15c to accept first transfer rollers 13Y, 13M, 13C, 13B. At each position corresponding to respective image-forming units 5 through 8 disposed above inter-stage transfer belt 3, a pair of triggers 26, each of which has a symmetrical shape with trigger 15, is arranged so as to sandwich belt 3. Engaged with the sliding motion of guide members 19 and 20, triggers 15 and 26 have in-phase rotation. Therefore, when the movement engaged guide member 19 with trigger 15 is mentioned in the explanation of the present invention, it implies that guide member 20 and trigger 26 have in-phase rotation as well.

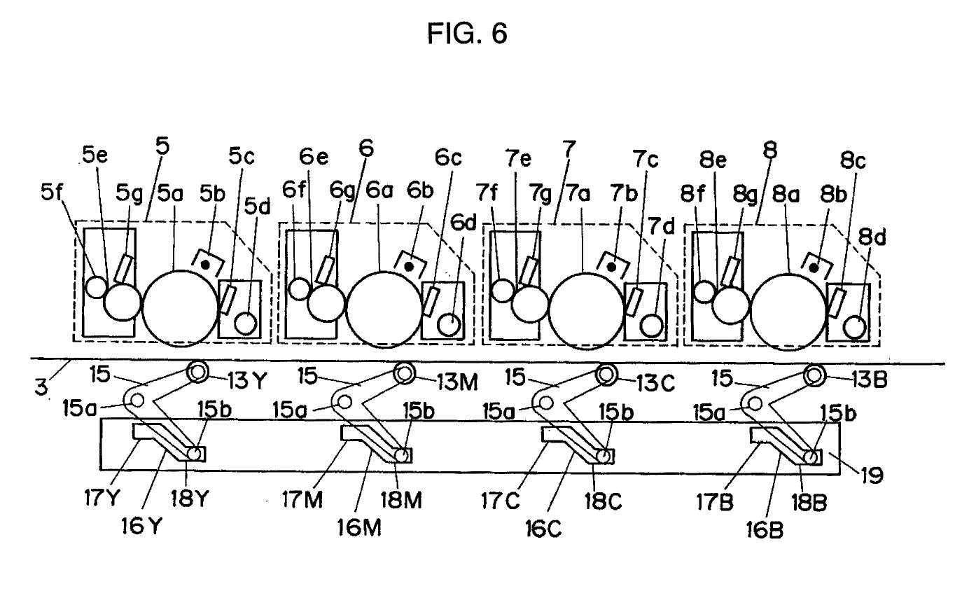

FIG. 6 is a schematic view showing the engaging relation between the trigger and the guide member when all of the first transfer rollers stay in the disengaging positions. Image-forming units 5 through 8 in the figure have the structure same as unit 5 for yellow (Y) shown in FIG. 2. The engagement between guide pin 15b of trigger 15 and each of guides 16Y, 16M, 16C, and 16B formed on guide member 19 is the same as that shown in FIG. 2. That is, each guide pin 15b stays at disengaging stages 18Y through 18B of guides 16Y through 16B, first transfer rollers 13Y through 13B also stay in disengaging position, thereby keeping belt 3 away from photosensitive drums 5a through 8a.

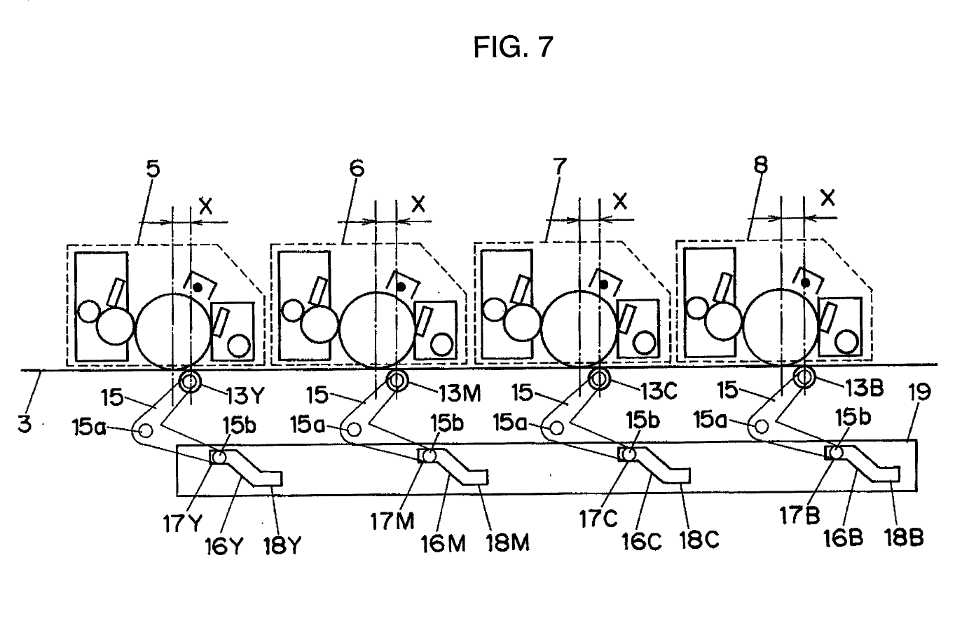

FIG. 7 is a schematic view showing the engaging relation between the trigger and the guide member when all of the first transfer rollers stay in the engaging positions. As shown in the figure, the sliding motion of guide member 19—the rightward sliding from the state shown in FIG. 6—slides each guide pin 15b up to engaging stages 17Y through 17B via the ramp formed on respective guides 16Y through 16B. First transfer rollers 13Y through 13B accordingly move into the engaging position, by which belt 3 comes into contact with drums 5a through 8a.

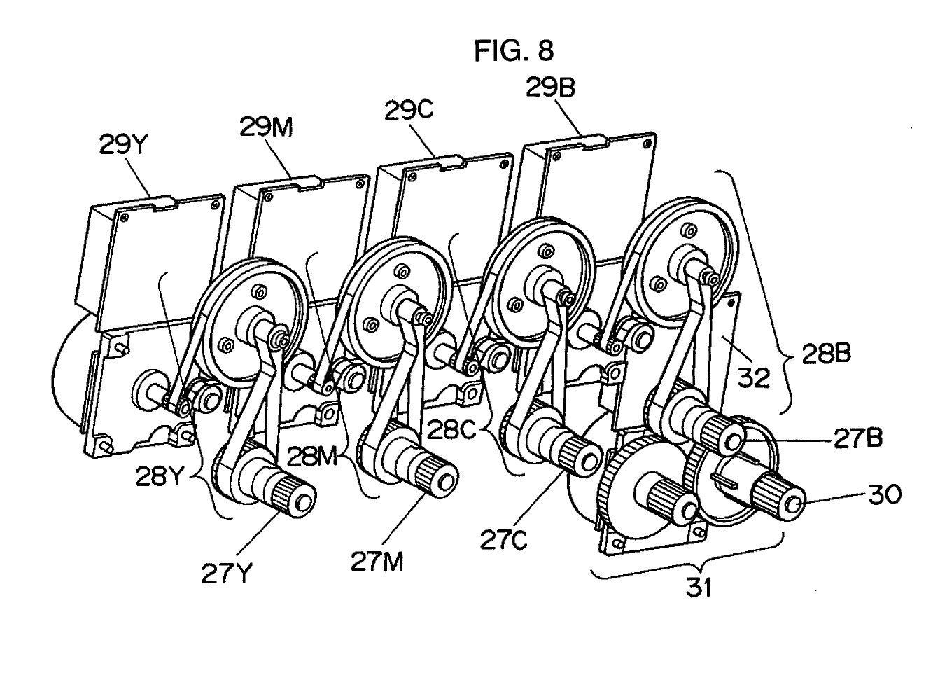

FIG. 8 is a perspective view indicating driving units of the color-image forming apparatus. In FIG. 8, drum-joint gears 27Y, 27M, 27C, and 27B are male coupling members having involute-toothed edges on their outer surfaces. Belt modules 28Y, 28M, 28C, 28B—a combination of timing belts and pulleys—and drum motors (i.e., drum drivers) 29Y, 29M, 29C, 29B are disposed corresponding to each of drum-joint gears 27Y through 27C. Rotational force generated by drum motors 29Y through 29B is transmitted to drum-joint gears 27Y through 27B via belt modules 28Y through 28B, respectively. The driving unit also includes belt-joint gear 30, belt module 31 for driving gear 30, and belt motor (i.e., belt driver) 32. Like the drum-joint gear, belt-joint gear 30 is a male coupling member having involute-toothed edge on its outer surface.

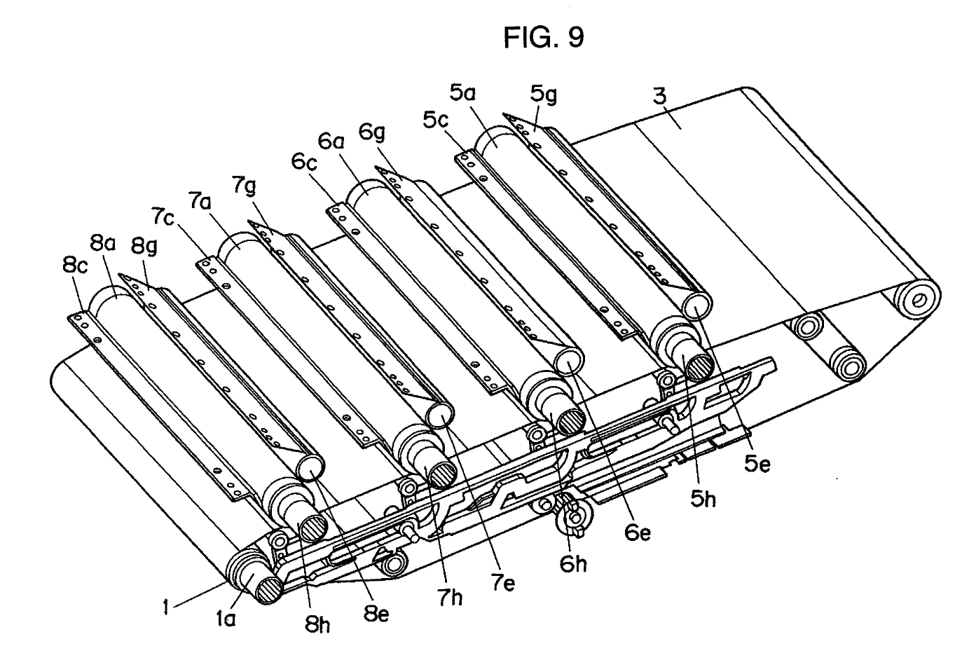

FIG. 9 is a perspective view indicating how the inter-stage transfer belt unit is arranged with respect to the image-forming unit.

As shown in the figure, photosensitive drums 5a through 8a have coaxially arranged drum gears 5h, 6h, 7h, and 8h on their one end. Each drum gear has a female coupling section with its inner surface involute-toothed. Drum gears 5h, 6h, 7h, and 8h engage with drum-joint gears 27Y, 27M, 27C, and 27B in FIG. 8, respectively. Belt-drive roller 1 has coaxially arranged belt gear 1a on its one end. Belt gear 1a has a male coupling section whose inner surface is edged with involute-tooth to engage with belt-joint gear 30.

Now will be described how these units work. Responding to the print-start signal, belt motor 32 runs belt 3 in the direction indicated by the arrow A in FIG. 1. Then, drum motors 29Y through 29B start to rotate drums 5a through 8a. After that, the driving system of the apparatus transmits a driving force via joint gear 25 to pinion 24, thereby guide member 19 starts to slide from the position shown in FIG. 6—the initial position—to its stroke-end. Engaging with the sliding motion of guide member 19, each guide pin 15b travels each ramp of guide 16Y through 16B and reaches engaging stages 17Y through 17B. As guide pin 15b moves, first transfer rollers 13Y through 13B rotate on support pin 15a to each engaging position. Belt 3 comes into contact with drums 5a through 8a, as shown in FIG. 7.

In image-forming unit 5, charger 5b evenly charges the surface of drum 5a. According to yellow-image information fed from exposure unit 9, an electrostatic latent image is formed on the charged surface of drum 5a. On developing roller 5e, spreading blade 5g evenly spreads yellow toner, which was supplied from supply roller 5f, and charges it by friction from the rubbing movement. Depending on the potential difference in voltage placed between drum 5a and developing roller 5e, the toner adheres to the latent image formed on drum 5a, thereby the latent image becomes visible. The visualized yellow-toner image is transferred onto inter-stage transfer belt 3 by applying a high potential voltage to first transfer roller 13Y.

In tandem with the transfer process for the yellow-toner image, an electrostatic latent image for magenta is formed on drum 6a in image-forming unit 6. In the same manner as the process in unit 5, magenta toner evenly spread on developing roller 6e adheres to the magenta latent image to be visible. By application of high potential voltage to roller 13M, the visualized magenta-toner image on drum 6a is transferred onto belt 3 that has already carried the yellow-toner image processed in unit 5, so that the magenta-toner image is overlapped with the yellow one.

Like the transfer process in units 5 and 6, the cyan-toner and the black-toner images formed in image-forming units 7 and 8 are transferred onto belt 3 by applying a high potential voltage to rollers 13C and 13B, respectively. Through these processes, belt 3 finally carries a full-color toner image thereon.

After that, as joint gear 25 rotates in reverse, guide member 19 resumes the sliding motion and moves back to the initial position—the opposite stroke end. Engaging with the sliding motion of guide member 19, each guide pin 15b travels—just in reverse of the engaging process—each ramp of guide 16Y through 16B and returns to disengaging stages 18Y through 18B. Accordingly, first transfer rollers 13Y through 13B move to the disengaging positions, allowing belt 3 to keep away from drums 5a through 8a. When belt 3 is away from drums 5a through 8a, all of drum motors 29Y through 29B stops its rotation, thereby all of drums 5a through 8a comes to a stop, too.

When sheet P fed from paper cassette 10 passes between belt 3 and second transfer roller 11, the full-color toner image carried on belt 3 is transferred onto sheet P by one operation. The transferred image on sheet P is finally affixed with heat by fixing unit 12 then sheet P is ejected from the apparatus. Following the completion of the series of the image-forming process, belt motor 32 stops its rotation to stop belt 3.

According to the embodiment of the present invention, as described above, running belt 3 comes into contact with rotating drums 5a through 8a only while the toner images on drums 5a through 8a are transferred to belt 3. Compared with the conventional structure in which the belt contacts with the drums all through the process, this minimized contact reduces damage or abrasion likely occurred when the drums and the belt start to rotate. As a result, degradation in image quality is substantially suppressed and the service life will be extended. Furthermore, the structure does away with the need to drive in unison belt motor 32 and drum motors 29Y through 29B, promising reduced power consumption.

When belt 3 comes into contact with, or goes away from drums 5a through 8a, the both devices experience impact vibrations—small but not negligible. Therefore, if the engaging/disengaging motion is performed in the process of forming latent image onto drums 5a through 8a by exposure unit 9, the vibrations can adversely affect sensitive latent image. Furthermore, when belt 3 goes away from drums 5a through 8a, the upper half (divided by roller 1 and roller 2) of the belt becomes momentarily shorter than the lower half, accordingly decreasing the running speed of belt 3. Therefore, if the disengaging motion is performed in the transfer process of the toner image on belt 3 onto sheet P by second transfer roller 11, the toner image on the sheet can be adversely affected.

For such reasons, according to the embodiment:

i) engaging belt 3 with drums 5a through 8a prior to the exposure process; and

ii) disengaging belt 3 from drums 5a through 8a after transferring the toner image onto sheet P.

Considering the timing above protects the transferred result from disturbance caused by impact vibrations, realizing a clearer toner image.

Now will be described recovery procedures from a halt caused by paper jamming or other operational failures that can arise in the series of the image-forming process, and the initializing operation performed at power-up of the apparatus. The description here is focused on the movement of image-forming units 5 through 8 and inter-stage transfer belt unit 21.

The main operation for initializing image-forming units 5 through 8 is to clean out the residual toner on drums 5a through 8a, which has not been transferred onto belt 3. For the cleaning, drums 5a through 8a have to be rotated at least one round. Similarly, the main operation for initializing belt unit 21 is to clean out the residual toner on belt 3, which has not been transferred onto sheet P.

According to the embodiment, drums 5a through 8a have 30-mm outside diameter—that is, the length of its circumference equals to 94.2 mm, and close-looped belt 3 has 848 mm circumference. Suppose that such sized drum and belt are employed for the conventional structure in which the belt contacts with the drums at all times, and that the drums and the belt rotate at a same speed with each other. In this case, drums 5a through 8a have to rotate some 9 turns while belt 3 runs a round for cleaning operation. This unnecessarily initializing operation of units 5 through 8 adversely affects each component of the units—drums 5a through 8a, cleaning blades 5c through 8c, developing rollers 5c through 8c, supply rollers 5f through 8f, and spreading blades 5g through 8g, seriously impairing their service lives.

To address the problem, as described above, drum motors 29Y through 29B driving image-forming units 5 through 8 and belt motor 32 driving inter-stage transfer belt unit 21 are independently structured. In addition, belt 3 comes into contact with drums 5a through 8a only while accepting the toner image from drums 5a through 8a. Such structure protects units 5 through 8 from wasteful movement than necessary to initialize operation, significantly increasing its service life.

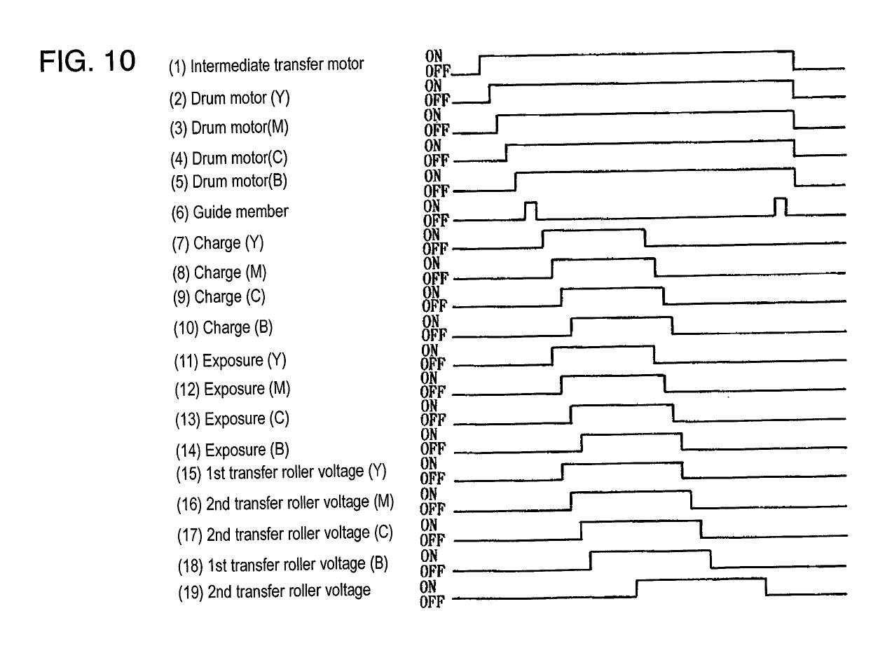

As described earlier, the current supply reaches its peak at the moment of driving a motor. Therefore, providing all of the motors, i.e., drum motors 29Y through 29B and belt motor 32 with a time-shifted start can suppress its power consumption. As shown in the timing chart of FIG. 10, after belt motor 32 and drum motors 29Y through 29B start in order at intervals over time, guide member 19 starts to move. It becomes thus possible to control the power consumption by driving belt motor 32 and drum motors 29Y through 29B with a time-shifted start.

Second Preferred Embodiment

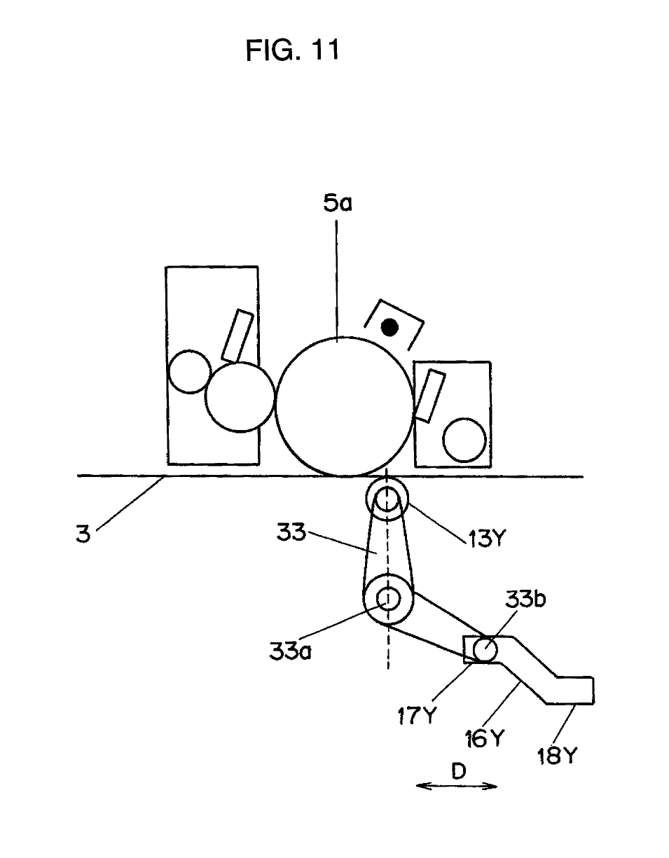

FIG. 11 schematically shows the image-forming unit for yellow and the trigger responsible to the unit in accordance with the second preferred embodiment.

As shown in the figure, trigger 33 is a variant of trigger 15 in FIG. 2. Having a structure basically the same as trigger 15, trigger 33 has its support pin 33a on the vertical of first transfer roller 13Y.

Generally L-shaped, trigger 33 rotates on support pin 33a fixed to the apparatus. In addition, guide pin 33b is disposed at a position properly spaced from support pin 33a. Controlling the position of guide pin 33b allows roller 13Y to position in place.

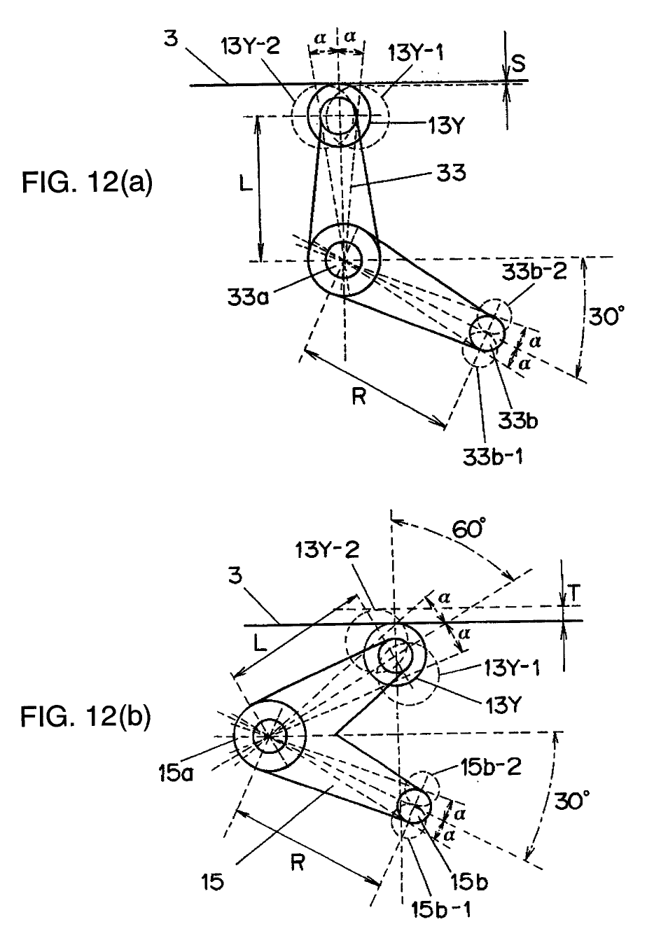

FIGS. 12 (a) and 12 (b) illustrate variations occurred when the first transfer roller comes into contact with the inter-stage transfer belt, comparing in using the trigger described in the embodiment with another type trigger in the first preferred embodiment.

In trigger 33 of FIG. 12 (a), support pin 33a is spaced distance L from roller 13Y in a vertical downward direction, while guide pin 33b is disposed at the position, keeping distance R equals to distance L and being angled at 30° from the horizontal. In the structure, positional errors can be caused from variations in molding process of trigger 33 and guide member 19, deflections occurred when guide-holding pin 23 fits in guide member 19, or guide pin 33b fits into the slot of guide member 19. The displacement caused above allows the precisely designed position to have within ±α a angled deflections. First transfer roller 13Y accordingly have within ±α a angled deflections with respect to its normal position. In the figure, when guide pin 33b is placed at the position indicated by the numeral 33b-1, roller 13Y comes to the position indicated by the numeral 13Y-1. Similarly, guide pin 33b at the numeral 33b-2 locates roller 13Y to the numeral 13Y-2.

On the other hand, in trigger 15 of FIG. 12 (b), support pin 15a is disposed on the line with a 60° angle to the vertical that passes through the center of roller 13Y and spaced distance L from the center. Guide pin 15b is disposed at the position, keeping distance R equals to distance L and being angled at 30° from the horizontal. Like trigger 33, positional errors allow the precisely designed position to have within ±α a angled deflections. First transfer roller 13Y accordingly have within ±α a angled deflections with respect to its normal position. In the figure, when guide pin 15b is placed at the position indicated by the number 15b-1, roller 13Y comes to the position indicated by the number 13Y-1. Similarly, guide pin 15b at the numeral 15b-2 locates roller 13Y to the numeral 13Y-2.

In the structure having such deflections, the key to a good transfer is to minimize variations in bite between drum 5a and belt 3. The difference in bite causes an inconsistent toner image transferred from drum 5a, and particularly when a fixed high voltage is applied to roller 13Y, the form of transferred toner image will be distorted. To avoid such inconveniences, in the both cases of roller 13Y shown in FIG. 12, it is required to minimize the displacement S—between the normal position and the deflected position indicated by the numeral 13Y-1 shown in FIG. 12 (a)—and the displacement T—between the normal position and the deflected position indicated by the numeral 13Y-2 shown in FIG. 12(b), respectively.

Variations in position of guide pin 33b develop the displacement S in FIG. 12 (a), while variations in position of guide pin 15b develop the displacement T in FIG. 12 (b). As is evident from both figures, the displacement observed in FIG. 12 (b) is larger than that in FIG. 12 (a). When performing a simulation on condition that L=R=40 (mm) and α=1, it works out the following result: S=0.006 (mm) and T=0.602 (mm). 0.006 (mm) and T=0.602 (mm). It is apparent from the result that T takes the value ten times greater than S does.

Therefore, disposing support pin 33a in a vertical downward direction with respect to roller 13Y ensures that the toner image on drum 5a is transferred in a good condition. This is also true for each trigger 15 responsible to rollers 13M through 13B.

Third Preferred Embodiment

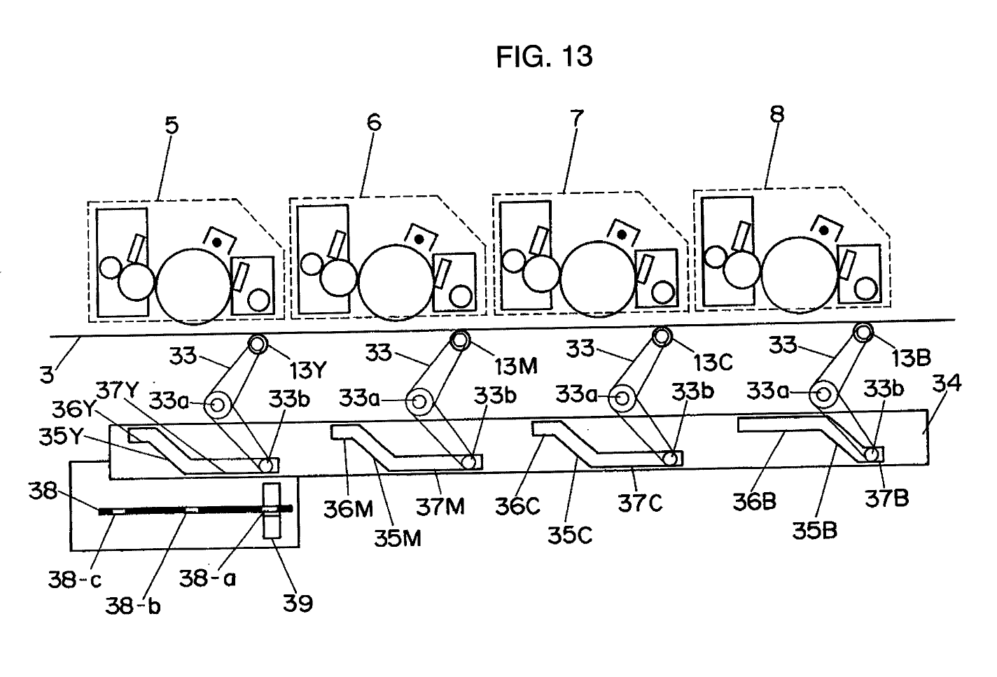

FIG. 13 is a schematic view of the image-forming apparatus, specifically showing the engaging relation between the trigger and the guide member when all of the first transfer rollers stay in the disengaging positions in accordance with the third preferred embodiment of the present invention.

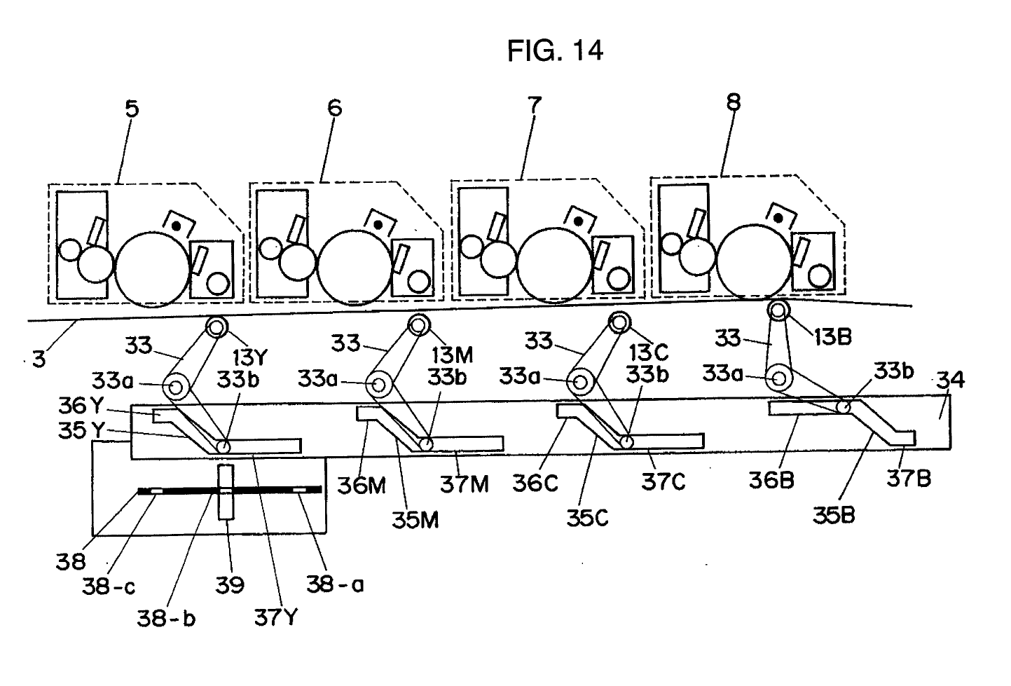

FIG. 14 is a schematic view showing the engaging relation between the trigger and the guide member when the first transfer roller responsible for black alone stays in the engaging position.

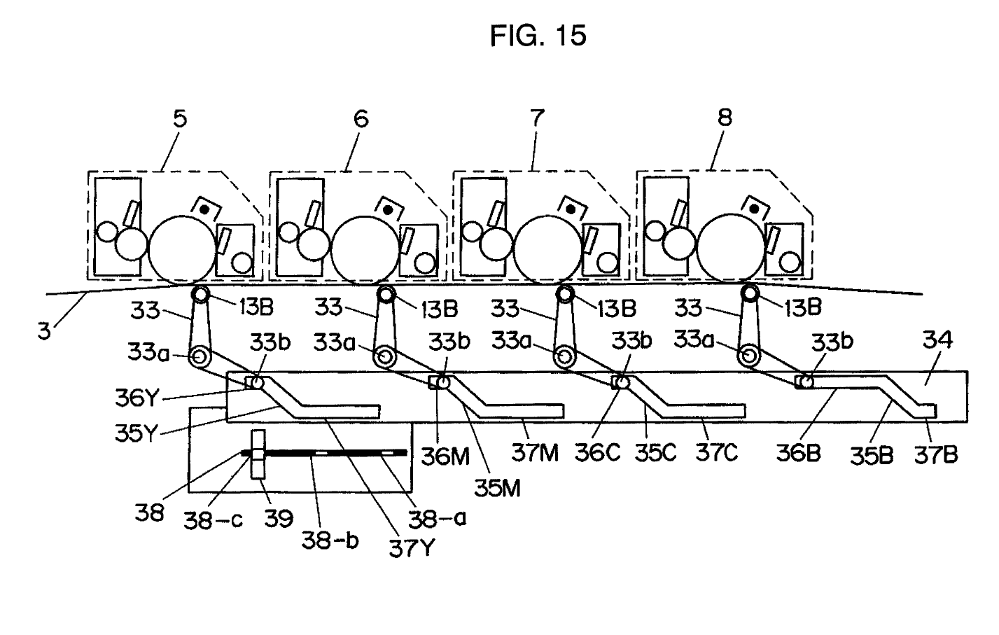

FIG. 15 is a schematic view showing the engaging relation between the trigger and the guide member when all of the first transfer rollers stay in the engaging positions.

Each structure of image-forming units 5 through 8 shown in FIGS. 13 through 15 is the same as that described earlier, arranged in the order of yellow (Y), magenta (M), cyan (C), and black (B) from left to right in each figure. Correspondingly disposed to respective units 5 through 8, rollers 13Y through 13B are held at both ends by trigger 33 described in FIG. 11. Trigger 33 can be replaced with trigger 15 described above. Like guide member 19, guide member 34 includes guides 35Y, 35M, 35C, and 35B and is movable in the lateral direction. Each of guides 35Y through 35B has i) engaging stages 36Y, 36M, 36C, 36B and ii) disengaging stages 37Y, 37M, 37C, 37B.

In these figures, guide 35B working for unit 8 for black (B) differs in its shape from other guides 35Y through 35C working for units 5 through 7. Guide 35B has engaging stage 36B whose length is longer than those of 36Y through 36C by a specified length, while guides 35Y through 35C have each disengaging stage whose length is longer than that of 37B by a specified length.

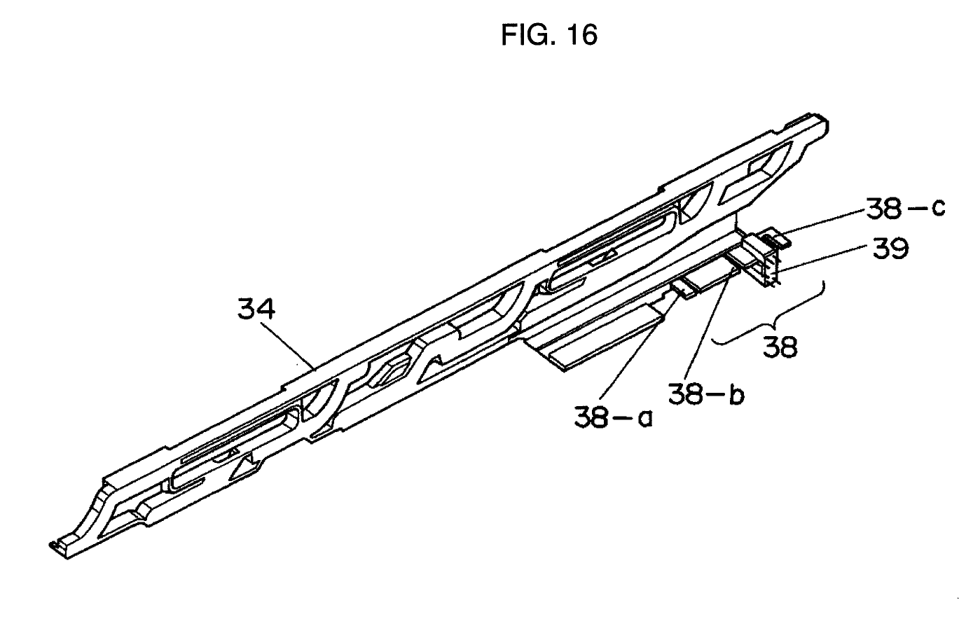

FIG. 16 is a perspective view indicating the positional relation between the guide member and the sensor in the image forming apparatus.

Sensor 39 is disposed on the side of the apparatus (not shown). Having a pass-through type detector, sensor 39 outputs transmitted light in the direction vertically to the moving direction of sensing opening 38. Slits 38-a, 38-b, and 38-c, which are disposed at opening 38, determine the stop position of guide member 34.

FIGS. 13 through 15 also show the relationship among slits 38-a through 38-c, sensor 39, and guide member 34. FIG. 13 shows the state in which slit 38-a is in alignment with the optical axis of sensor 39. FIG. 14 shows the state in which guide member 34 has a rightward shift from the state shown in FIG. 13 and slit 38-b comes in alignment with the optical axis of sensor 39. FIG. 15 shows the state in which guide member 34 goes farther rightward from the state shown in FIG. 14 and slit 38-c comes in alignment with the optical axis of sensor 39.

As described earlier, FIG. 13 shows the state that all of the first transfer rollers stay in the disengaging positions. Under the state, slit 38-a is alignment with the optical axis of sensor 39. As guide member 34 shifts rightward from the state at a fixed speed, guide pin 33b of trigger 33 working for unit 8 for black (B) slides the ramp of guide 35B up to engaging stage 36B. Guide member 34 comes to a stop, with slit 38-b being alignment with the optical axis of sensor 39. In the meantime, trigger 33 rotates on support pin 33a in a counterclockwise direction, by which roller 13B reaches the engaging position while pushing up inter-stage transfer belt 3. In contrast to the movement of guide pin 33b for unit 8, other guide pins 33b—working for rollers 13Y through 13C—only move on respective disengaging stages 37Y, 37M, 37C, with no contribution to the rotation of trigger 33. Therefore, belt 3 comes into contact with only drum 8a responsible for black (B), allowing the black-toner image only to be transferred. During the transfer process of the black-toner image, other units 5 through 7 can be at rest. That is, this operation is effective in forming monochrome image. On the completion of the monochrome-image forming, guide member 34 shifts back leftward and stops with roller 13Y through 13B shown in FIG. 13 being in the disengaging positions.

Now will be described the movement in forming color images. To perform the color-image transfer, rollers 13Y through 13B have to leave the disengaging positions and goes into the state shown in FIG. 15 via the state in FIG. 14 described above. Here will be explained in some detail. Guide member 34 starts to shift rightward from the state in which slit 38-a is in alignment with the optical axis of sensor 39 shown in FIG. 13. At this time, guide member 34 comes into a stop at slit 38-c, passing through slit 38-b. When guide member 34 passes through slit 38-b, roller 13B comes into its engaging position. A farther leftward shift of guide member 34 brings guide pins 33b of each trigger 33 for respective rollers 13Y through 13C to engaging stages 36Y through 36C via ramps of guides 35Y through 35C. Following roller 13B, roller 13Y through 13C come into each engaging position thereby belt 3 comes into a contact with all drums 5a through 8a. In this way, a color-toner image can be formed. When the image forming completes, the guide member and other involved components follow the procedure in reverse to get back to the initial state.

As described above, in the structure of the embodiment, i) guide 35B for black (B) differs in shape from other guides 35Y through 35C; ii) having such structured guides 35Y through 35B, guide member 33 shifts in a step-by-step manner. With the structure, the two modes—monochrome-image forming and color-image forming—can be selectively performed. When forming a monochrome image, other image-forming units—units 5, 6, 7 for yellow (Y), magenta (M), cyan (C), respectively—can be at rest. This improvement in printing a monochrome-image independently without wasteful movement of other units increases the longevity of units 5 through 7.

Although units 5 through 8 are arranged in order of yellow (Y), magenta (M), cyan (C), black (B) from left to right in FIGS. 13 through 15, the arrangement is not limited to this: any arrangement will be acceptable as long as the position of guide 35B of guide member 34 corresponds to the position of image-forming unit for black (B).

Fourth Preferred Embodiment

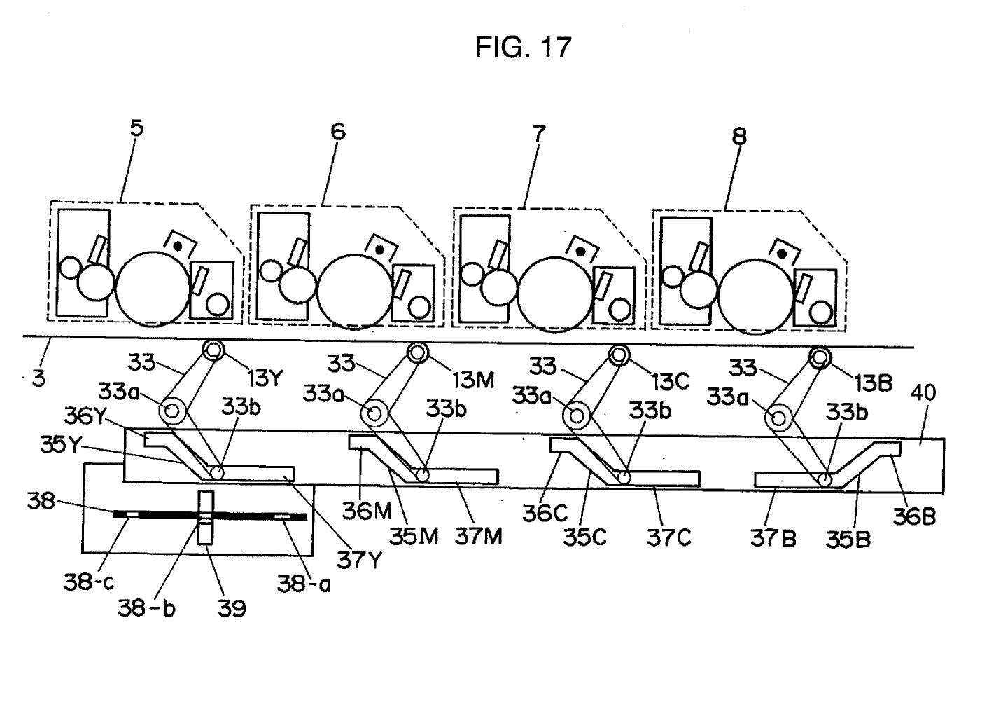

FIG. 17 is a schematic view of the image-forming apparatus, specifically showing the engaging relation between the trigger and the guide member when all of the first transfer rollers stay in the disengaging positions in accordance with the fourth preferred embodiment of the present invention.

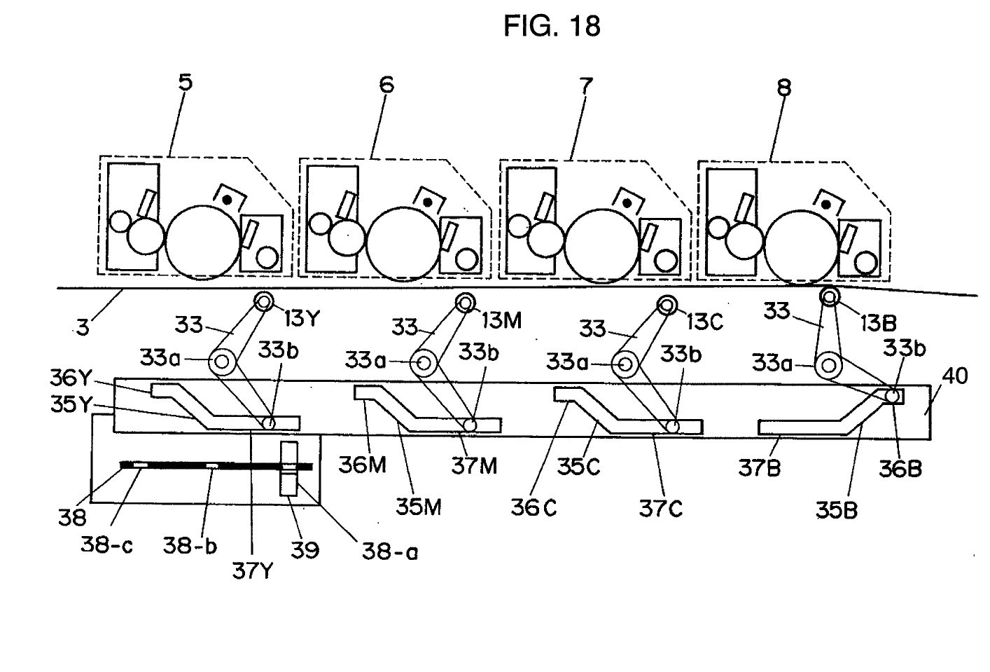

FIG. 18 is a schematic view showing the engaging relation between the trigger and the guide member when the first transfer roller responsible for black alone stays in the engaging position.

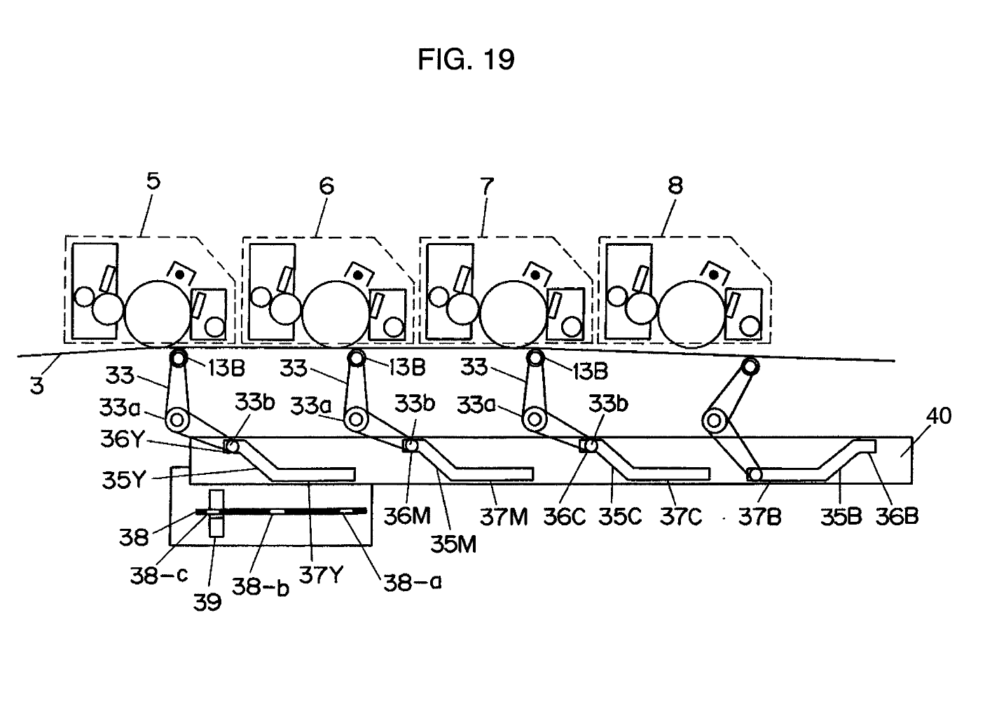

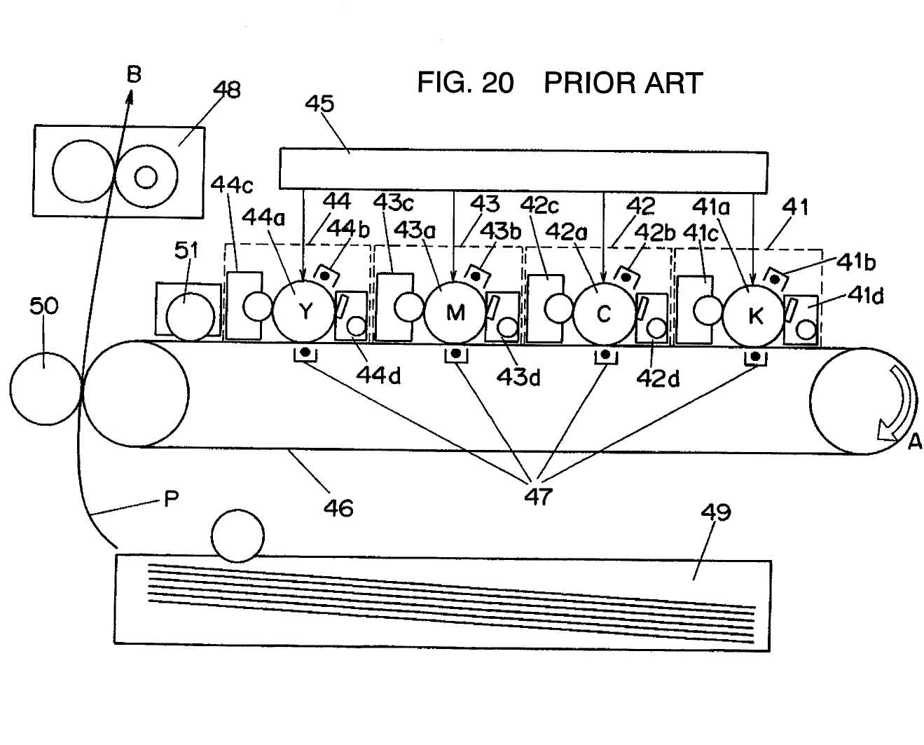

FIG. 19 is a schematic view showing the engaging relation between the trigger and the guide member when all the first transfer rollers but the roller for black stay in the engaging positions.

Each structure of image-forming units 5 through 8 shown in FIGS. 17 through 19 is the same as that described earlier, arranged in the order of yellow (Y), magenta (M), cyan (C), and black (B) from left to right in each figure. Correspondingly disposed to respective units 5 through 8, rollers 13Y through 13B have trigger 33 the same as that shown in FIGS. 13 through 15. Like guide member 34, guide member 40 includes guides 35Y, 35M, 35C, and 35B and is movable in the lateral direction. Each of guides 35Y through 35B has i) engaging stages 36Y, 36M, 36C, 36B and ii) disengaging stages 37Y, 37M, 37C, 37B.

According to the embodiment, guide 35B corresponding to unit 8 for black (B) is disposed in symmetrical relation to the positioning of other guides 35Y through 35C corresponding to units 5, 6, 7 for yellow (Y), magenta (M), cyan (C), respectively. For such arrangement, the engaging relation in the initial state between guide pin 33b and guide 35B differs from that between other guides and each guide pin 33b. Sensor 39, which senses the shift position of guide member 40, and sensing opening 38 of guide member 40 are structured in a manner similar to those shown in FIG. 16. The linkage movement between guide member 40 and trigger 33 is basically the same as each one shown in FIGS. 13 through 15.

Sensor 39 senses slit 38-b in FIG. 17. This is the initial state in which rollers 13Y through 13B stay in the disengaging positions. To form a monochrome image, guide member 40 shifts toward the left at a fixed speed until sensor 39 senses slit 38-a. While shifting, guide pin 33b of trigger 33 working for unit 8 for black (B) slides the ramp of guide 35B up to engaging stage 36B. In the meantime, trigger 33 rotates on support pin 33a in a counterclockwise direction, by which roller 13B reaches the engaging position shown in FIG. 18 while pushing up inter-stage transfer belt 3.

In contrast to the movement of guide pin 33b of trigger 33 for roller 13B, other guide pins 33b—working for rollers 13Y through 13C—only move on respective disengaging stages 37Y, 37M, 37C, with no contribution to the rotation of trigger 33. Therefore, belt 3 comes into contact with only drum 8a responsible for black (B), allowing the black-toner image only to be transferred. During the transfer process of the black-toner image, other units 5 through 7 can be at rest. On the completion of the monochrome-image forming, guide member 40 in FIG. 18 shifts back rightward. When slit 38-b comes in alignment with the optical axis of sensor 39, guide member 40 stops with roller 13B shown in FIG. 17 settled in the disengaging position.

Here will be described the movement in forming color images. Guide member 40 now shifts toward the right at a fixed speed until sensor 39 senses slit 38-c. In the meantime, each trigger 33 corresponding to units 5, 6, 7 for yellow (Y), magenta (M), cyan (C), respectively, rotates on each support pin 33a, thereby rollers 13Y through 13C come into the engaging positions. In contrast to the movement of each guide pin 33b of trigger 33 for rollers 13Y through 13C, guide pins 33b working for roller 13B only move on disengaging stage 37B with no act on the rotation of own trigger 33. Therefore, belt 3 comes into contact with drums 5a through 7a, which are at-least-needed for color-image forming. When the image forming completes, the guide member and other involved components follow the procedure in reverse to get back to the initial state.

As described above, in the structure of the embodiment, guide 35B for black (B) differs in shape from other guides 35Y through 35C. Having such structured guides thereon, guide member 40 shifts toward right or left from the initial state according to the two modes of monochrome-image forming and color-image forming.

According to the structure, image-forming unit 8 for black (B) can be at rest during the color-image forming. This promises an increased service life of unit 8. Although units 5 through 8 are arranged in order of yellow (Y), magenta (M), cyan (C), black (B) from left to right in FIGS. 17 through 19, the arrangement is not limited to this: any arrangement will be acceptable as long as the position of guide 35B of guide member 40 corresponds to the position of image-forming unit for black (B).

According to the present invention, as described above, the inter-stage transfer belt comes into contact with the photosensitive drum only while the toner image on the drum is transferred onto the belt, minimizing damage or abrasion caused from rubbing against each other. It becomes thus possible to greatly increase the longevity of the photosensitive drum that is the “heart” of the image-forming unit. It also contributes an extended service life of the drum and the belt for precisely controlled image quality.

What is claimed is:

1. A color-image forming apparatus comprising:
an exposure unit;
plural image-forming units arranged in a tandem manner, having separately different color toner therein, each of which further including:
a photosensitive drum on which an electrostatic latent image is formed by the exposure unit; and
a developing unit forming a toner image by applying toner onto the latent image; and
an endless inter-stage transfer belt transferring plural toner images of different colors formed on each drum by overlapping one after another while traveling an endless path looped over plural rollers along in a direction of an arrangement of the image-forming units,
wherein the inter-stage transfer belt comes into contact with the photosensitive drums only while accepting the toner image formed on the photosensitive drums.

2. The color-image forming apparatus of claim 1, wherein both of engaging and disengaging motions between the inter-stage transfer belt and the photosensitive drums are performed while the belt and the drums are both in operation.

3. The color-image forming apparatus of claim 2, wherein the inter-stage transfer belt comes into contact with the photosensitive drums prior to an exposure process by the exposure unit, and goes away from the drums after the color toner image is transferred by one operation onto a recording material.

4. The color-image forming apparatus of claim 2, wherein a belt-drive unit running the inter-stage transfer belt and a drum-drive unit rotating the photosensitive drums that carry the plural images of different colors are independently structured, and the belt-drive unit and the drum-drive unit are to be driven in order with a time-shifted start.

5. The color-image forming apparatus of claim 1, wherein plural movable rollers are arranged, on the side of an inner circumference of the inter-stage transfer belt, at positions corresponding to each position of the photosensitive drums, the movable rollers are disposed to be movable in a direction toward the drums thereby the inter-stage transfer belt comes into contact with the photosensitive drums to transfer a toner image formed on the photosensitive drums onto the inter-stage transfer belt one upon another for forming a full-color image.

6. The color-image forming apparatus of claim 5, wherein the movable roller is made of metal.

7. The color-image forming apparatus of claim 5, wherein a transfer voltage is applied to the movable rollers to transfer the toner image visualized on the photosensitive drum onto the inter-stage transfer belt.

8. The color-image forming apparatus of claim 6, wherein a transfer voltage is applied to the movable rollers to transfer the toner image visualized on the photosensitive drum onto the inter-stage transfer belt.

9. The color-image forming apparatus of claim 5, wherein a guide member movable back and forth is disposed along in a direction of a layout of the image-forming units, plural triggers, while supporting the movable rollers, rotates with the back-and-forth motion of the guide member are disposed, rotation of the triggers caused by the guide member provides the movable roller's movement toward the drums with a rotary control, allowing the inter-stage transfer belt to come into contact with the photosensitive drums.

10. The color-image forming apparatus of claim 9, wherein each of the plural triggers includes a shaft-support section of the movable roller and a support-point section on which the trigger rotates, the shaft-support section and the support-point section generally lie on a vertical line when the inter-stage transfer belt comes into contact with the photosensitive drums.

11. The color-image forming apparatus according to any one of claim 5 and 9, wherein the movable rollers, each of which is disposed corresponding to the plural image-forming units, move with a same timing.

12. The color-image forming apparatus according to any one of claim 5 and 9, wherein the plural image-forming units include a monochrome-image forming unit and at least different two color-image forming units, in a monochrome-image forming process, of the movable rollers, one that corresponds to the monochrome-image forming unit moves alone to allow the inter-stage transfer belt to contact with the photosensitive drum;
in a color-image forming process, all of the movable rollers move to allow the inter-stage transfer belt to contact with the photosensitive drums.

13. The color-image forming apparatus according to any one of claim 5 and 9, wherein the plural image-forming units include a monochrome-image forming unit and at least different two color-image forming units,
in a monochrome-image forming process, of the movable rollers, one that corresponds to the monochrome-image forming unit moves alone to allow the inter-stage transfer belt to contact with the photosensitive drum;
in a color-image forming process, all of the movable rollers but one that corresponds to the monochrome-image forming unit move to allow the inter-stage transfer belt to contact with the photosensitive drums.
